(19) United States
(12) Patent Application Publication
(10) Pub. No.: US 2024/0394553 A1
(43) Pub. Date: Nov. 28, 2024

(54) AUGMENTING REINFORCEMENT LEARNING WITH LOCAL EXPLAINABILITY WEIGHTS

(71) Applicant: Capital One Services, LLC, McLean, VA (US)

(72) Inventors: Samuel SHARPE, Cambridge, MA (US); Christopher Bayan BRUSS, Washington, DC (US); Brian BARR, Schenectady, NY (US)

(73) Assignee: Capital One Services, LLC, McLean, VA (US)

(21) Appl. No.: 18/323,123

(22) Filed: May 24, 2023

(51) Int. Cl. G06N 3/092; G06F 40/279; G06F 40/30; G06V 10/46; G06V 10/82; G06V 20/70

(52) U.S. Cl. CPC G06N 3/092; G06F 40/279; G06F 40/30; G06V 10/46; G06V 10/82; G06V 20/70

(57) ABSTRACT

A method and related system of operations include providing a set of feature values to determine a first reward value to a prediction model configured with a set of model parameters and obtaining a set of feature weights for features of the set of feature values by performing a local explainability operation that comprises providing the prediction model with a set of test inputs to determine a set of feature weights. The method also includes selecting a subset of feature weights of the set of feature weights based on a feature subset of the features indicated by a policy parameter of the prediction model, determining a reward modification value based on the subset of feature weights, and determining a second reward value based on the first reward value and the reward modification value. The method also includes updating the set of model parameters based on the second reward value.

### SUMMARY

Reinforcement learning is a type of machine learning operation in which an agent of the reinforcement learning model learns to make a sequence of actions by interacting with an environment. The agent receives feedback in the form of rewards based on the actions it takes, where the agent is trained to learn a policy that maximizes the cumulative reward over time. Reinforcement learning can be effective in training agents to make recommendations and decisions in a wide variety of domains. Reinforcement learning is particularly effective in situations where the environment is complex and dynamic and where the optimal solution is not known in advance. By exploring the environment and receiving feedback in the form of rewards, the agent can learn to make decisions that maximize the cumulative reward over time. However, in many cases, the features that the agent uses to make decisions may be biased or the result of malicious inputs in the environment of the agent. This technical problem is exacerbated by the behavior of users or entities that perform actions that form a training history for the user or entity for the purpose of mistraining a local reinforcement learning model.

Some embodiments may overcome such technical problems by using local explainability parameters to update a reward value used to train a prediction model. Some embodiments may provide a set of feature values representing a training state and a training output state to determine an initial reward value to a reinforcement learning model configured with a set of model parameters of the prediction model. Some embodiments may then obtain local explainability weights for the feature set based on the set of model parameters by performing a local explainability operation that comprises providing the prediction model with a plurality of combinations of candidate feature values to determine the local explainability weights. Some embodiments may select a subset of feature weights of the local explainability weights indicated by a subset of policy-flagged features, where the feature set includes the subset of policy-flagged features. Some embodiments may then determine a reward modification value based on the subset of feature weights and determine a modified reward value based on the reward modification value (e.g., by subtracting the reward reduction value from the initial reward value). Some embodiments may then update the set of model parameters based on the modified reward value by retraining the prediction model with the modified reward value.

Various other aspects, features, and advantages will be apparent through the detailed description of this disclosure and the drawings attached hereto. It is also to be understood that both the foregoing general description and the following detailed description are examples and not restrictive of the scope of the invention.

### BRIEF DESCRIPTION OF THE DRAWINGS

Detailed descriptions of implementations of the present technology will be described and explained through the use of the accompanying drawings.

FIG. 1 depicts an example of a system for updating a reinforcement learning model based on a set of local explainability weights, in accordance with some embodiments.

FIG. 2 depicts a diagram of an explainability weight-modified reinforcement learning model, in accordance with some embodiments.

FIG. 3 shows a flowchart of a process for modifying message headers, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form in order to avoid unnecessarily obscuring the embodiments of the invention.

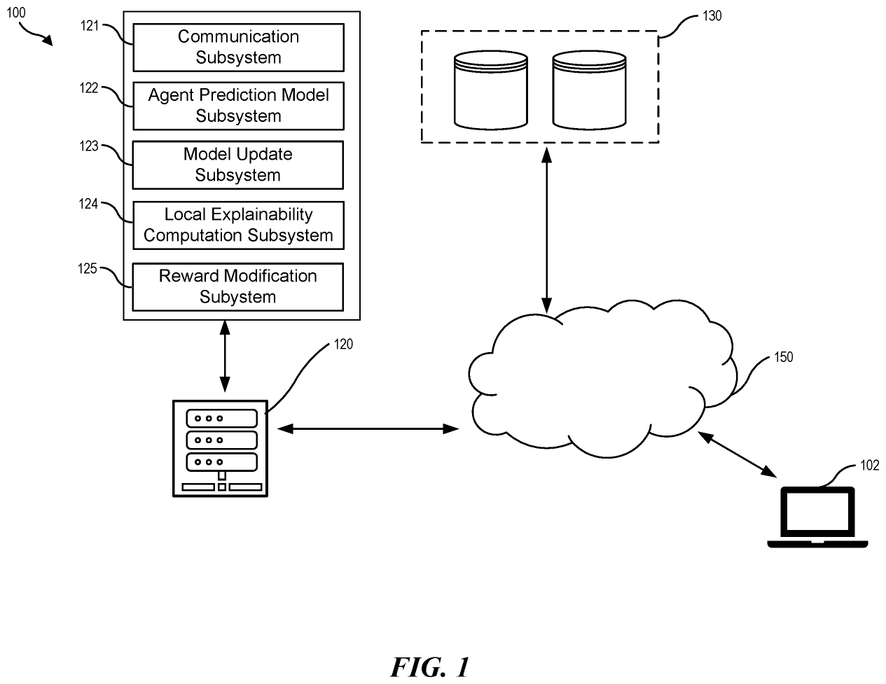

FIG. 1 depicts an example of a system for updating a reinforcement learning model based on a set of local explainability weights, in accordance with some embodiments. The example system 100 includes a client computing device 102 used by a first user. While shown as a laptop computer, it should be noted that the client computing device 102 may include other types of computing devices such as a desktop computer, a wearable headset, a smartwatch, another type of mobile computing device, etc. In some embodiments, the client computing device 102 may communicate with various other computing devices via a network 150, where the network 150 may include the Internet, a local area network, a peer-to-peer network, etc. The network 150 permits communication, including the sending and receiving of messages, between the client computing device 102, a server 120, and a set of databases 130.

The server 120 may include or have access to a set of non-transitory, computer-readable media (e.g., “storage media”) storing program instructions to perform one or more operations of subsystems 121-125. The server 120 may be executed as a standalone server, as a set of set of applications and scripts as a part of a cloud-supported set of computing operations, a server service implemented on a cloud system, etc. It should be understood that a “server” may be implemented as a physical machine, a virtual machine, or as software that performs server services.

In some embodiments, the set of computer systems and subsystems illustrated in FIG. 1 may include one or more computing devices having electronic storage or otherwise capable of accessing electronic storage, where the electronic storage may include the set of databases 130. The set of databases 130 may include values used to perform operations described in this disclosure, such as data associated with prediction models (e.g., model parameters), program instructions, local explainability weights, etc.

In some embodiments, a communication subsystem 121 may perform communication operations to send and receive messages between the server 120 and other computer devices accessible via the network 150, such as the client computing device 102 or the databases 130. The communication subsystem 121 may obtain data from the databases 130, such as feature values, policy parameters, etc. As used in this disclosure, a policy parameter may include a learning model parameter (e.g., neural cell weight, bias, activation function parameter, neural cell memory parameter, etc.). A policy parameter may also include other types of parameters, such as an identifier of feature types, feature weight thresholds, or other values associated with feature types. The communication subsystem 121 may also send data to computer devices accessible via the network 150. For example, the communication subsystem 121 may send data to the client computing device 102 to provide predictions of a reinforcement learning model, where an implementation of a reinforcement learning model may include an implementation of a reinforcement learning model agent and a representation of an environment.

The communication subsystem 121 may obtain feature data from a set of databases, physical sensors, information provided by a user via a graphic user interface, etc., where the feature data may represent an environment of a reinforcement learning model. The communication subsystem 121 may also collect data regarding the types of actions that a reinforcement learning model agent may provide as an output. For example, the communication subsystem 121 may retrieve a set of categories representing possible actions that a learning model may take. Furthermore, the communication subsystem 121 may send program instructions, encrypted information, data structures, or other types of data to the set of databases 130, the client computing device 102, or other computing devices. For example, the communication subsystem 121 may send, via the network 150, a trained prediction model to the databases 130 for storage.

The agent prediction model subsystem 122 may perform various operations related to training a reinforcement learning model agent (“agent”) to predict a set of actions implemented as outputs of a prediction model. An agent may include a prediction model and an implementation of a reinforcement learning algorithm. The agent prediction model subsystem 122 may provide feature values representing an environment state to an agent such that a prediction model of the agent may output a prediction. Some embodiments may then use the outputted prediction to determine a reward value, as described elsewhere in this disclosure.

The prediction model of an agent may be implemented using various types of machine learning models or statistical models. For example, some embodiments may use a neural network model to provide predictions based on an input set of feature values, where the neural network model may include a feed-forward neural network model having a few neural network layers, a deep neural network model, a recurrent neural network model, a convolutional neural network, a transformer neural network, etc. Furthermore, some embodiments may provide various types of outputs, such as numeric outputs, categorical outputs (e.g., binary outputs), vector outputs, etc. For example, the agent prediction model subsystem 122 may provide a prediction model with an input set of feature values representing an environment of a database transaction to obtain, as an output of the prediction model, a categorical value indicating that the database transaction is based on fraudulent activity.

The configuration of a prediction model may represent a portion of the state of an agent's policy, where a policy may determine actions that an agent takes in response to an environment state. As described elsewhere in this disclosure, an implementation of a portion of a policy may include a function approximator that takes the state of the environment as input and produces a probability distribution over the available actions as output. For example, to determine a prediction using a prediction model, the agent prediction model subsystem 122 may generate a probability distribution over an available set of predictions generated using the prediction model and then select a prediction based on the probability distribution.

Some embodiments may use a model update subsystem 123 to update the model parameters of an agent prediction model. The model update subsystem 123 may configure a set of model parameters of an agent by training the agent using collected data and an implementation of a reinforcement learning algorithm of the agent. To train the agent, the model update subsystem 123 determines a reward value based on the output of an agent prediction model or an environment state associated with the output, where the output may have been provided by the prediction model after the prediction model obtained a set of feature values as inputs. The model update subsystem 123 may use at least one of various types of reward functions to determine a reward value, such as a shaped reward function (i.e., a reward function that provides a reward based on achieving at least one objective of a set of objectives as reflected by a corresponding set of states), a sparse reward function (i.e., a reward function that provides a reward based on achieving an objective when reaching a terminal environmental state), a dense reward function (i.e., a reward function that provides a reward for each action taken), a curiosity-based reward function (i.e., a reward function that increases when an agent recommends an action that results in a novel/unencountered environmental state), etc.

The model update subsystem 123 may then update the agent's learning model parameters using an implementation of a reward learning algorithm to maximize an expected reward value based on that output. For example, an agent's prediction model may include a neural network. The model update subsystem 123 may use a policy gradient method to update a set of model parameters of the neural network by adjusting the model parameters to increase an expected reward value (e.g., a cumulative reward value over a sequence of neural network outputs). Implementing a policy gradient may include computing the gradient of an expected reward with respect to the model parameters of the neural network and using this gradient to update the network parameters through backpropagation.

As will be described elsewhere in this disclosure, some embodiments may update the model parameters based on multiple reward values for a same set of feature values. For example, some embodiments may use a model update subsystem 123 to determine a first reward value and then determine a first updated version of a prediction model based on the first reward value. As described elsewhere in this disclosure, some embodiments may compute a set of local explainability weights and update the first reward value based on the set of local explainability weights. The model update subsystem 123 may then modify the parameters of the prediction model based on the modified reward value to determine a second updated version of the prediction model.

The local explainability computation subsystem 124 may use a set of local explainability operations to determine a set of feature weights corresponding with the set of features, where the set of feature weights may be a set of local explainability weights or may be derived from the set of local explainability weights. A local explainability weight for a feature provided to a prediction model may indicate a numerical representation of the importance of the feature to the value of a prediction model output. A local explainability operation may include one or more various types of operations such as a Local Interpretable Model-Agnostic Explanations (LIME) operation, a SHapley Additive exPlanations (SHAP) operation, a Deep Learning Important FeaTures (DeepLIFT) operation, or a layer-wise relevance propagation operation. As described elsewhere in this disclosure, local explainability weights may be used to update a reward value to prevent a system from relying on biased or malicious features.

The reward modification subsystem 125 may update a reward value based on one or more local explainability weights. The reward modification subsystem 125 may obtain a set of flagged features and a corresponding set of feature weight criteria. For example, some embodiments may obtain a collection of flagged features from a record stored in the set of databases 130, where the collection of flagged features may include “ZIP Code,” “marital status,” and “occupation type.” Some embodiments may then determine a reward modification value based on the presence of one or more flagged features for features indicated by a set of feature weights. For example, the reward modification subsystem 125 may select a subset of feature weights based on a match with an obtained collection of flagged features. Some embodiments may then determine a reward modification value based on the subset of feature weights, and some embodiments may use the reward modification value to determine a modified reward value.

Various types of mathematical operations may be used to determine a modified reward value based on a set of local explainability weights. For example, such operations may include performing addition, multiplication, exponentiation, square roots, or other roots, etc. In some embodiments, the selection of a set of flagged features may be done via a dot product multiplication, where an array may include a non-zero value (e.g., “1”) in an element corresponding with a flagged feature and may include a zero value “0” in an element that does not correspond with a flagged feature. For example, some embodiments may determine a product of a preconfigured constant value and a sum of the feature weights for a set of flagged features and subtract the product from a reward value. Some embodiments may perform such operations by multiplying, using a dot product operation, a first vector representing the feature weights by a second vector that has “0” for all elements corresponding with non-flagged features and “1” for all elements corresponding with all flagged features and then multiplying the dot product by the preconfigured constant. For example, after determining that a sum of the feature weights for flagged features of a feature set is equal to “1.9,” some embodiments may multiply the feature weights by a preconfigured constant “5.0” to determine a reward modification value equal to “9.5.” Some embodiments may then subtract a first reward value “11.6” by the reward modification value “9.5” to determine a modified reward value “2.1,” where the model update subsystem 123 may use this modified reward value to retrain a prediction model.

Some embodiments may apply a threshold value to a set of feature weights to determine whether one or more weights of the feature weights will be used to modify a reward value. For example, some embodiments may determine a set of feature weights “[0.5, 0.39, 0.1, 0.01]” representing the set of features ‘[“f1”; “f2”; “f3”; “f4”].’ Some embodiments may then determine that f3 and f4 are listed in a set of policy-flagged features and compare these feature weights to a feature weight threshold of 0.05 representing a feature weight criterion, the features may be flagged using one or more parameters of a set of policy parameters. A policy-flagged feature may be flagged by a user or an automated system and may include demographic features such as a feature representing race, age, disability status, gender, marital status, other familial status (e.g., having a child), sexual orientation, etc. Based on a detection that the feature weight for the feature “f3” exceeds the feature weight threshold, some embodiments may update the reward modification value to decrease the corresponding modified reward value. Based on a detection that the feature weight for the feature “f4” does not exceed the feature weight threshold, some embodiments may leave the reward modification value unchanged with respect to the value of the feature weight “f4.” By using thresholds, some embodiments may account for systems designed for partial optimization.

A set of flagged features may be indicated as malicious features based on a determination that the set of flagged features is associated with intentionally misleading or intentionally obfuscating operations. For example, some embodiments may use a reward learning system to detect a malicious use of a registered user's information. A real-world operation may include a plurality of activity types translated into features that are performed for the purpose of obfuscating one or more malicious actions. Some embodiments may update a prediction model trained using a reinforcement learning operation to account for the inclusion of a set of malicious features by indicating features known to be highly correlated with the set of malicious features and then flagging these indicated features as malicious features.

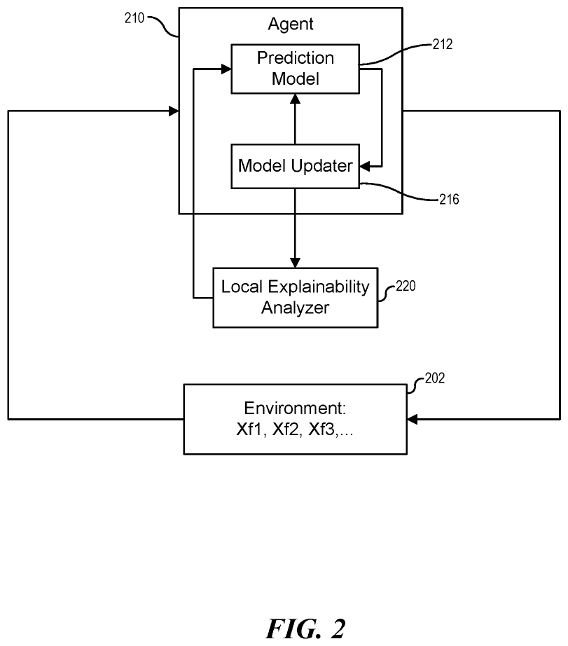

FIG. 2 depicts a diagram of an explainability weight-modified reinforcement learning model, in accordance with some embodiments. An environment 202 may be represented by a set of feature values, where the set of feature values (e.g., “Xf1,” “Xf2,” “Xf3”) may be provided to an agent 210. The agent 210 may include a prediction model 212 and a model updater 216. The environment 202 may include simulated data, real-world data, or data derived from other environment data. Furthermore, one or more features of the set of feature values may be indicated as a flagged feature or being associated with a flagged feature. For example, the environment 202 may be represented in part by a feature “VPN type,” where “VPN type” is flagged as being an indicator of malicious activity.

Some embodiments may provide a prediction model 212 of the agent 210 with a set of feature values representing the state of the environment 202. The prediction model 212 may then provide a prediction as an output of the prediction model 212 based on a policy implemented by the prediction model 212. In some embodiments, the prediction model 212 may select a prediction from a set of possible predictions based on a set of probability values corresponding with the set of possible predictions. For example, the prediction model 212 may use a random number to select a prediction, where the random number is generated using a probability distribution derived from the probability values. Alternatively, the prediction model may compute an expected cumulative reward value for each possible prediction of a set of possible predictions and select the prediction associated with the greatest expected cumulative reward value. In some embodiments, the expected cumulative reward may be based on previously computed reward values, where a reward value may be a function of an output of the prediction model 212 and an environment state and where the expected cumulative reward may be made over a series of steps. While the policy of the prediction model 212 may be implemented with a neural network model, some embodiments may use other machine learning models for use as a prediction model, such as a decision tree model, a random forest model, a support vector machines (SVM) model, etc. Furthermore, in some embodiments, a prediction model may include a statistical model, where the parameters of the statistical model may be updated based on a corresponding reward value.

The model updater 216 may then determine an initial reward value based on outputs provided by the prediction model 212. For example, the prediction model 212 may use a set of neural network layers of a neural network to determine a first output representing an agent action, and the model updater 216 may determine an initial reward value based on the first output. Once the prediction is made, some embodiments may determine a reward value based on the prediction by evaluating the effect of the prediction on a new state and determining a reward value based on a difference between the new state and the state defined by the training set of feature values. The prediction model 212 may then determine a reward value based on a difference between an initial training state value and the state value after or if the reward value is implemented. Some embodiments may then update a prediction model by updating the set of model parameters of the prediction model based on the reward value.

Some embodiments may use a local explainability analyzer 220 to determine a set of feature weights. The local explainability analyzer 220 may perform a local explainability operation to determine the relative importance of the features provided to the prediction model 212 with respect to their effect on an output of the prediction model 212. For example, the local explainability analyzer 220 may perform a SHAP operation by generating a set of test inputs by perturbing values of the feature values representing the environment 202. Some embodiments may then provide the set of test inputs to the prediction model 212 to determine a corresponding set of Shapley values for the features of the environment 202, where the Shapley values may represent contribution weights to an output of the prediction model 212.

Some embodiments may then use the Shapley values as feature weights and determine whether the feature weights satisfy a set of feature weight orders of the feature weights matches with a target order or whether a feature weight of a policy-flagged feature satisfies a feature weight threshold. For example, some embodiments may use a set of feature weights provided by the local explainability analyzer 220 to determine whether a first feature weight of a policy-flagged feature satisfies a feature weight threshold. In response to a determination that the feature weight threshold satisfies the feature weight threshold, some embodiments may then modify the initial reward value by subtracting a product of the first feature weight and a preconfigured constant value from the initial reward value to determine a modified reward value. By reducing the initial reward value, some embodiments may thus penalize the use of a policy-flagged feature. Alternatively, or additionally, some embodiments may use the local explainability analyzer 220 to determine a set of feature weights and then determine a feature order based on their corresponding weights. Some embodiments may then determine that the feature order does not match a target feature order and, in response, reduce the initial reward value.

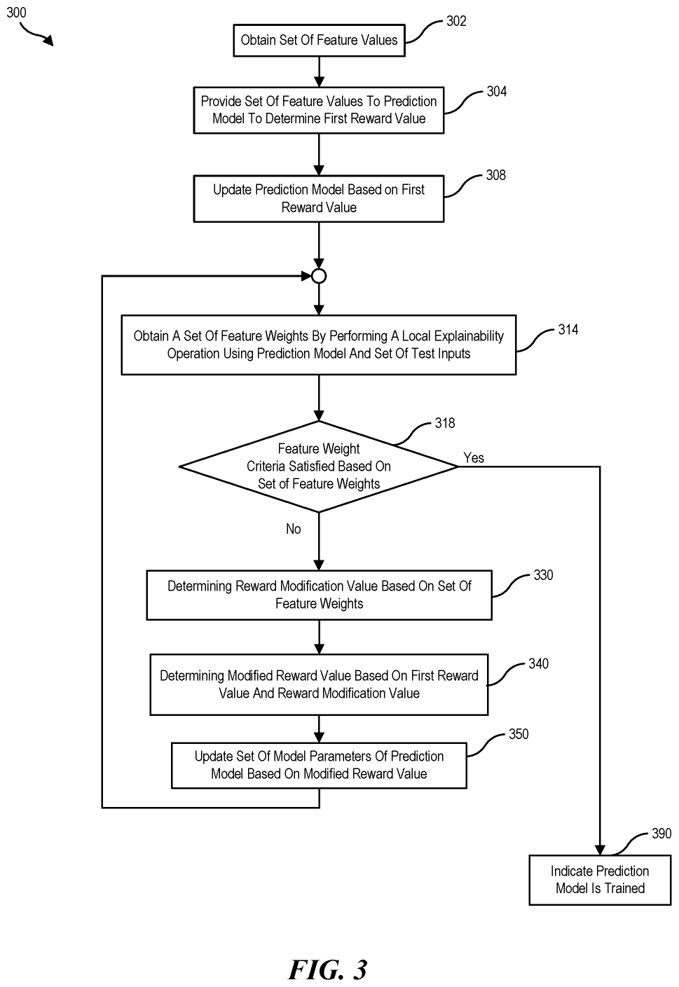

FIG. 3 shows a flowchart of a process for modifying message headers, in accordance with one or more embodiments. Some embodiments may obtain a set of feature values, as indicated by block 302. As described elsewhere in this disclosure, the set of feature values may be obtained from various sources and may represent state values of an environment for an agent of a reinforcement learning model. Each respective feature value of the set of feature values provided as an input corresponds with a feature of a feature set, where a combination of values of the feature set may be treated as the state of an environment for an agent in reinforcement learning. For example, a set of feature values may be represented by the array of numeric values “[0.11, 0.63, 0.12],” where the first element of the array may represent the state value of a normalized temperature, the second element of the array may represent the state value of a normalized viscosity, and the third element of the array may represent a normalized porosity. Some embodiments may treat this array of values as the state of an environment for reinforcement learning operations.

The set of feature values may include values obtained from a simulated system. For example, the set of feature values may include values obtained from a physics simulation representing different positions, masses, and velocities. Alternatively, or additionally, the set of features may include values obtained from a real-world system. For example, the set of features may include values obtained from a physical sensor or an oracle, such as a measurement of temperature, a measurement of pressure, a measurement of a price in a market for a set of items, etc. Alternatively, or additionally, the set of features may include values obtained from database transactions, such as a value of an amount of change in a record field caused by a database transaction, a number of times that a particular record was updated within a time range, etc. furthermore, the set of feature values may include various types of feature values, such as categorical values, numeric values, text values, etc.

Some embodiments may obtain text data and use the obtained text data to determine a one or more feature values. For example, some embodiments may obtain text data and detect a match between a portion of the text data and a character sequence identifier of a set of identifiers of one or more character sequences. A character sequence identifier may include the character sequence itself, a sequence of vectors representing tokens generated from the character sequence, etc. As described elsewhere, some embodiments may determine a set of policy parameters indicating features used to modify the set of feature values. Some embodiments may use a natural language processing model to determine one or more feature values. For example, some embodiments may segment a text into a set of text blocks using a set of rules and then use a transformer neural network to determine a respective token for each respective text block of the text, where a text block may include a sub-word, a word, a phrase, a sentence, a paragraph, or other text segments of the natural language text. Some embodiments may then determine a feature based on these tokens, such as by indicating a presence of a token in a document or a count of tokens representing the different versions of the same text block in the document.

Some embodiments may perform one or more operations described in this disclosure in real-time with respect to a data session between a client device and server. By performing operations in real-time, some embodiments may dynamically adjust recommendations, candidate actions, or other types of prediction model outputs while a user or computer system is using the prediction model outputs. Performing real-time operations may include obtaining feature values based on a data stream during a data session with a client computing device or another computing device. For example, some embodiments may obtain user-provided values and perform a normalization operation based on a user action to determine a set of feature values to be provided to a prediction model described in this disclosure, where a user action may be represented by a value indicating a user click, a user keyboard entry, a user interaction with a specified user interface element, etc. For example, some embodiments may obtain, via a data stream provided by the client computing device, a user action indicating that a user had accessed a web link or another type of user interface element on a website or application displayed on a client computing device. In response, some embodiments may update a feature value to indicate the interaction and include the feature value in a set of feature values to be provided to a prediction model. Alternatively, or additionally, some embodiments may use one or more of the user-provided values directly as feature values to be provided to a prediction model described in this disclosure. For example, some embodiments may receive the value “0.7” from a client computing device after a user directly enters the value “0.7” into a user interface displayed on the client computing device.

Some embodiments may obtain image data and use the image data to generate feature values for use as inputs for a prediction model being used in a reinforcement learning model, where image data may include single images, sequences of images, a video recording, a video stream, etc. For example, some embodiments may obtain an image, detect a set of shapes using one or more object detection algorithms, and use a trained transformer neural network (or another computer vision algorithm) to assign a set of object labels to the set of shapes. Some embodiments may determine a set of feature values based on the set of object labels. For example, some embodiments may provide a count of the times that an object label is uniquely assigned to a different shape in an image and use the count as a feature value. Alternatively, or additionally, some embodiments may determine a set of feature values based on the set of object labels by using the set of object labels directly as feature values.

Some embodiments may provide a set of feature values to a prediction model to determine a first reward value, as indicated by block 304. A prediction model may represent a policy of an agent in a reinforcement learning operation and may be implemented with a statistical model or a machine learning model. For example, some embodiments may implement a prediction model as a neural network, such as a deep neural network, a recurrent neural network, a transformer neural network, an ensemble system, etc. Once provided with the set of feature values, the prediction model of an agent may output a prediction, where the prediction may then be used to compute a first reward value.

A reward value may be a scalar value that reflects a score of a state-action pair, with higher scores indicating more desirable outcomes. During a reinforcement learning operation, the model parameters of an agent may be updated to maximize an expected cumulative reward. When determining a reward value, some embodiments may use an instantaneous reward function that is recomputed after each candidate action taken by an agent prediction model. Alternatively, some embodiments may use a delayed reward function that is computed only at the end of a sequence of actions provided by an agent prediction model.

Some embodiments may use one of various types of reward functions, such as goal-based reward functions, exploration-based reward functions, time-based reward functions, risk-based reward functions, etc. For example, some embodiments may implement a goal-based reward function that increases when a particular set of risk thresholds and or other thresholds are satisfied. In some embodiments, the reward function may also include a reward bonus for exploring a new candidate action or new environment that had previously not been explored.

Some embodiments may update a prediction model based on the first reward value, as indicated by block 308. Some embodiments may train the model parameters of a prediction model by using a supervised learning method, such as a policy gradient method. For example, some embodiments may compute the gradient of the expected reward with respect to the parameters of a prediction model neural network and use this gradient to update the network parameters through backpropagation. Furthermore, some embodiments may collect a trajectory of feature values representing states, prediction model outputs representing candidate actions, and reward values, where a trajectory may include a sequence of state-action pairs and the corresponding reward for each candidate action. Some embodiments may then determine an expected cumulative reward by computing a sum of the reward values for a particular trajectory. Some embodiments may then determine a policy gradient as the product of the expected cumulative reward and the gradient of a probability distribution (e.g., a log distribution) of the candidate action taken with respect to each respective model parameter, where the gradient indicates a quantitative effect that model parameter contributed to the candidate action taken and, by extension, to the expected cumulative reward. Some embodiments may then update model parameters based on a pre-configured learning rate in the direction of the gradient.

Some embodiments may retrieve a pre-trained model and may apply an additional set of trainable layers to determine a prediction model constructed from the pre-trained model. Alternatively, or additionally, some embodiments may further permit a user to update a received pre-trained model on a local data structure. Some embodiments may prevent significant deviation from the received, pre-trained model in order to preserve an absolute, a relative order of feature weights, a target range of feature weights computed from a SHAP operation, etc. Some embodiments may implement this objective by limiting changes to a prediction model to changes that satisfy a set of policy update constraints. For example, the set of policy update constraints may constrain or otherwise prevent model parameters from deviating more than 20% from their initially received value, where a model parameter may include a neural cell weight, a bias, an activation function parameter, a statistical function parameter, a memory function parameter, or other model parameters.

Some embodiments may obtain a set of feature weights by performing a local explainability operation using the prediction model and a set of test inputs, as indicated by block 314. A local explainability operation may provide weights for a set of features used as inputs for a prediction model, where the weights indicate a relative importance of the outputs of the prediction model corresponding with the set of test inputs. As described elsewhere, such operations may include a LIME operation, a SHAP operation, a DeepLIFT operation, etc. For example, some embodiments may use a LIME operation by generating a local linear model to approximate the behavior of a trained agent/policy near the provided feature values and then perturbing the feature values to form a set of test inputs (i.e., a plurality of combinations of candidate feature values). Some embodiments may then observe how the agent output change with respect to the different combinations of feature values to determine a LIME output that can be used to compute a corresponding feature weight.

Alternatively, or additionally, some embodiments may use a SHAP operation to assign contribution scores to each of the features. For example, some embodiments may use a set of SHAP operations to determine one or more Shapley values that represent a set of contribution weights associated with a set of feature values provided to a prediction model. To determine a set of contribution weights, some embodiments may provide a set of inputs that include multiple subsets of candidate feature values to a prediction model to obtain a plurality of candidate output values. For example, some embodiments may build a plurality of combinations of candidate feature values based on an initial set of feature values by perturbing the feature values based on preconfigured perturbation range. Some embodiments may then use the Shapley values to compute an average (or some other measure of central tendency) contribution weight of each feature to the model's predictions over the different subsets of feature combinations. For example, some embodiments may compute the Shapley values for each feature based on the set of contribution weights corresponding with the feature, where a contribution weight indicates the change to a reward value and where the different contribution weights reflect changes created by using different combinations of candidate feature values. Some embodiments may then, for each respective feature, set the feature weights to be equal to a respective contribution weight. As described elsewhere in this disclosure, some embodiments may then select features having their feature weights set as being equal to or derived from a contribution weight, where an increase in the contribution weight may cause a correlated decrease in a reward value used to train a prediction model.

Some embodiments may determine a feature weight that is derived from a local explainability operation output. Some embodiments may use the output of a local explainability model directly. For example, some embodiments may use a Shapley value for a feature as the feature weight for that feature. Alternatively, some embodiments may apply further transformations to the output of a local explainability model.

Some embodiments may use combinations of the outputs of different types of local explainability operations for a feature to determine a feature weight. For example, some embodiments may determine a LIME output for a first feature and a DeepLIFT output for the first feature. Some embodiments may then compute a mean average of the two outputs and use the mean average as a feature weight for the feature.

Some embodiments may determine whether a set of feature weight criteria is satisfied based on the set of feature weights, as indicated by block 318. The set of feature weight criteria may include one or more criteria and may be determined based on the set of feature weights determined using a local explainability operation. In some embodiments, satisfying a feature weight criterion may include satisfying a numeric value, such as a feature weight threshold. Some embodiments may indicate that a particular feature weight is less than a weight threshold. For example, some embodiments may determine that a feature weight for a feature of a measured feature value provided by a sensor is less than a weight threshold assigned to the feature. In response, some embodiments may visually indicate the sensor in a graphical display, where a user may use this visual indication to locate the sensor or perform operations to change the sensor configuration. In some embodiments, a feature weight that is less than a corresponding weight threshold may indicate that a sensor is malfunctioning. By indicating a sensor having a feature weight that is less than a weight threshold, some embodiments may provide a user with a means of fixing, locating, or otherwise effecting changes on the sensor. Furthermore, some embodiments may be configured to cause one or more operational changes on the sensor. For example, based on a determination that a feature weight of a feature provided by the sensor or derived from measurements provided by the sensor is less than a corresponding weight threshold, some embodiments may send instructions to recalibrate the sensor or perform a power cycle operation of the sensor.

In some embodiments, satisfying a set of feature weight thresholds may include satisfying a feature order criterion, where the feature order criterion may be based on a sequence of features that is ordered by the corresponding feature weights. For example, a set of features may include “f1,” “f2,” and “f3.” Based on their corresponding feature weights, a first feature order for the set of features may be “f1, f3, f2.” Some embodiments may then determine whether this feature order satisfies a feature order criterion that an edit distance (i.e., Levenshtein distance) between feature order and a target feature order “f3, f1, f2” is less than a threshold, where the target feature order may be obtained from a set of policy parameters. Some embodiments may determine an edit distance by constructing a matrix of distances between pairs of sub-sequences in the sequences. Some embodiments may then use the matrix to find the shortest path between the two sequences, which represents the minimum number of edit operations needed to transform one sequence into the other. For example, some embodiments may determine that the edit distance between the two feature orders is “2” and that this edit distance is less than the feature order criterion threshold of “3.” In response, some embodiments may determine that the feature order criterion is satisfied.

Some embodiments may compare a collection of flagged features with a set of feature weights to select a first subset of feature weights having a feature type in the collection of flagged features without selecting a second subset of feature weights having a feature type in the collection of flagged features. For example, some embodiments may select a first feature weight and a second feature weight for being of the types “marital status” and “occupation type.” Some embodiments may further filter this initial subset of feature weights based on one or more corresponding thresholds. For example, some embodiments may obtain a feature weight threshold equal to 0.14. Some embodiments may then select the first feature weight and not the second feature weight for a second subset of selected feature weights based on a detection that the first feature weight is greater than the feature weight threshold “0.14” and that the second feature weight is less than the feature weight threshold “0.14.”

In response to a determination that the set of feature weight thresholds is satisfied, operations of the process 300 may proceed to block 390. Otherwise, operations of the process 300 may proceed to block 330.

Some embodiments may determine a reward modification value based on the set of feature weights, as indicated by block 330. Various types of algorithms may be used for a reward modification value based on a set of feature weights. In many cases, an increase in the absolute value of the feature weights may cause a corresponding increase in the absolute value of a reward modification value. Some embodiments may use arithmetic operations to determine a reward modification value. For example, some embodiments may determine a reward modification value by summing the feature weights and then multiplying the sum by a preconfigured constant. Some embodiments use other types of mathematical operations to determine a reward modification value.

Some embodiments may select a subset of feature weights based on a feature subset indicated by a policy parameter of the prediction model as being biased or malicious. Some embodiments may select a feature subset that includes one or more types of values, such as a numeric value, a text value, a categorical value, a geographic location, etc. For example, some embodiments may select a numeric value and a geographic location to include in the subset of feature weights based on a determination that the numeric value is for the feature “age” and that the geographic location is for the feature “ZIP Code,” where a collection of policy-flagged features includes the feature “age” and the feature “ZIP Code.” Furthermore, some embodiments may obtain a set of correlation values from a dataset indicating a correlation between a first feature and a second feature, where the first feature is already flagged as malicious or biased. In response to a determination that the first feature is highly correlated to the second feature (e.g., having a correlation greater than a correlation threshold), some embodiments may flag the second feature as malicious or biased. For example, some embodiments some embodiments may determine that feature “customFeature1” has a 90% correlation with “gender” and that this satisfies the correlation threshold of “85%.” In response, some embodiments may treat “customFeature1” as a policy-flagged feature if “gender” is itself a custom-flagged feature. Some embodiments may then perform operations described in this disclosure to determine a feature weight for “customFeature1.” Some embodiments may then compare this feature weight with a corresponding feature weight threshold using operations described for block 318 to determine whether to perform one or more operations described for block 330. Various other values for a correlation threshold may be used, such as a value greater than 10%, a value greater than or equal to 50%, a value greater than or equal to 80%, a value greater than or equal to 90%, a value greater than or equal to 95%, a value greater than or equal to 99%, etc.

Some embodiments may use a natural language processing model to select important features. For example, as described elsewhere in this disclosure, some embodiments may use a natural language processing model to determine a set of features based on natural language text. Some embodiments may use a sentiment analysis operation to assign a set of sentiment scores to the corresponding set of text blocks based on an internal dictionary of sentiment scores. For example, some embodiments may use a trained machine learning model to predict sentiments for a set of text blocks of natural language text. Some embodiments may select a subset of the features based on their corresponding sentiment scores. For example, some embodiments may provide a first set of vectors representing different tokens as features to a prediction model using operations similar to those described for block 304. Some embodiments may then select a subset of the features based on their corresponding sentiment scores, where the sentiment scores may be used as feature weights or used to compute feature weights.

Some embodiments may limit a reward modification value to be less than or equal to a reward modification threshold. In response to a determination a reward modification value exceeds a reward modification threshold, some embodiments may modify the reward modification value to a preset value, such as the reward modification threshold itself or a value less than the reward modification threshold. For example, some embodiments may determine that a reward modification value is equal to “0.4,” and this value exceeds the associated reward modification threshold of “0.25.” In response, some embodiments may update the reward modification value to be equal to “0.25.”

Some embodiments may determine a modified reward value based on the first reward value and the reward modification value, as indicated by block 340. Some embodiments may limit the extent of a difference between a modified reward value and an initial reward value to be within a threshold range. For example, some embodiments may determine that an initial reward value determined from providing a prediction model is equal to 1.4 and that a corresponding modified reward value determined from modifying the initial reward value using a set of local explainability values is equal to 0.2. Some embodiments may determine that the modified reward value exceeds the threshold range that limits modified rewards as being less than the initial reward value and greater than 0.4. In response, some embodiments may reset the modified reward to be 0.4. In some embodiments, the threshold range may be a preset value that does not change with respect to a previously calculated reward value. Alternatively, the threshold range may change with respect to a previously calculated reward value.

Some embodiments may update the set of model parameters of the prediction model based on the modified reward value, as indicated by block 350. Some embodiments may have one or more operations described for block 304 to update the prediction model based on the modified reward value. For example, some embodiments may compute a policy gradient based on a modified reward value and update model parameters of a neural network using the policy gradient.

Some embodiments may indicate that the prediction model is trained, as indicated by block 390. After determining that the prediction model satisfies the set of feature weight thresholds, some embodiments may indicate that the prediction model is trained and ready for migration into a different computing environment or for model testing. For example, after determining that a first prediction model satisfies a corresponding prediction, some embodiments may update a record identifying the first prediction model in a database table of prediction models by changing a field of the record to indicate that the model is ready for migration into a testing server.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on a set of non-transitory, machine-readable media, such as an electronic storage medium. Furthermore, the use of the term “media” may include a single medium or combination of multiple media, such as a first medium and a second medium. The processing devices may include one or more devices configured through hardware, firmware, and/or software to be specifically designed for the execution of one or more of the operations of the methods. For example, it should be noted that any of the devices or equipment discussed in relation to FIGS. 1-2 could be used to perform one or more of the operations in FIG. 3.

It should be noted that the features and limitations described in any one embodiment may be applied to any other embodiment herein, and a flowchart or examples relating to one embodiment may be combined with any other embodiment in a suitable manner, done in different orders, or done in parallel. In addition, the systems and methods described herein may be performed in real-time. It should also be noted that the systems and/or methods described above may be applied to or used in accordance with other systems and/or methods.

In some embodiments, the various computer systems and subsystems illustrated in FIG. 1 may include one or more computing devices that are programmed to perform the functions described herein. The computing devices may include one or more electronic storages (e.g., the set of databases 130), one or more physical processors programmed with one or more computer program instructions, and/or other components. For example, the set of databases may include a relational database such as a PostgreSQL™ database or MySQL database. Alternatively, or additionally, the set of databases 130 or other electronic storage used in this disclosure may include a non-relational database, such as a Cassandra™ database, MongoDB™ database, Redis database, Neo4j™ database, Amazon Neptune™ database, etc.

The computing devices may include communication lines or ports to enable the exchange of information with a set of networks (e.g., network 150) or other computing platforms via wired or wireless techniques. The network may include the Internet, a mobile phone network, a mobile voice or data network (e.g., a 5G or Long-Term Evolution (LTE) network), a cable network, a public switched telephone network, or other types of communications networks or combination of communications networks. The network 150 may include one or more communications paths, such as Ethernet, a satellite path, a fiber-optic path, a cable path, a path that supports Internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems 121-125 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of subsystems 121-125 may provide more or less functionality than is described. For example, one or more of subsystems 121-125 may be eliminated, and some or all of its functionality may be provided by other ones of subsystems 121-125. As another example, additional subsystems may be programmed to perform some or all of the functionality attributed herein to one of subsystems 121-125 described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interfaces nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “a element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Furthermore, unless indicated otherwise, updating an item may include generating the item or modifying an existing time. Thus, updating a record may include generating a record or modifying the value of an already-generated value.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

### ENUMERATED EMBODIMENTS

The present techniques will be better understood with reference to the following enumerated embodiments:

1. A method comprising: providing, to a prediction model configured with a set of model parameters, a set of feature values to determine a first reward value; obtaining a set of feature weights for features of the set of feature values by performing a local explainability operation based on a set of test inputs for the prediction model; determining a reward modification value based on the set of feature weights and a set of policy parameters indicating one or more features; determining a second reward value based on the first reward value and the reward modification value; and updating the set of model parameters based on the second reward value.

2. A method comprising: providing, to a reinforcement learning model agent configured with a set of model parameters, a set of feature values representing a training state and a training output state to determine an initial reward value, wherein each respective feature value of the set of feature values corresponds with a feature of a feature set; obtaining local explainability weights for the feature set based on the set of model parameters by performing a local explainability operation that comprises providing the reinforcement learning model agent with a plurality of combinations of candidate feature values to determine the local explainability weights; selecting a subset of feature weights of the local explainability weights indicated by a subset of policy-flagged features, wherein the feature set comprises the subset of policy-flagged features, and wherein the subset of policy-flagged features represents malicious features; determining a reward reduction value based on the subset of feature weights; determining a modified reward value by subtracting the reward reduction value from the initial reward value; and updating the set of model parameters based on the modified reward value by retraining the reinforcement learning model agent with the modified reward value.

3. A method comprising: providing, to a prediction model configured with a set of model parameters, a set of feature values to determine a first reward value, wherein each respective feature value of the set of feature values corresponds with a feature of a feature set; obtaining a set of feature weights for features of the set of feature values by performing a local explainability operation that comprises providing the prediction model with a set of test inputs to determine a set of feature weights; selecting a subset of feature weights of the set of feature weights based on a feature subset of the features indicated by a policy parameter of the prediction model; determining a reward modification value based on the subset of feature weights; determining a second reward value based on the first reward value and the reward modification value; and updating the set of model parameters based on the second reward value.

4. The method of any of embodiments 1 to 3, wherein: providing the plurality of combinations of candidate feature values to the reinforcement learning model agent comprises determining a plurality of candidate output values as outputs of the reinforcement learning model agent; performing the local explainability operation further comprises: determining a set of contribution weights associated with the set of feature values by, for each respective feature of the set of feature values, determining a respective contribution to the plurality of candidate output values; and setting the local explainability weights to be equal to the set of contribution weights; the subset of feature weights comprises a selected contribution weight; and determining the reward reduction value comprises increasing the reward reduction value based on the selected contribution weight.

5. The method of any of embodiments 1 to 4, wherein determining the second reward value comprises reducing the first reward value based on a first feature weight of the subset of feature weights in response to a detection that the first feature weight satisfies a weight threshold.

6. The method of any of embodiments 1 to 5, wherein the set of feature values comprises a measured feature value provided by a sensor, further comprising indicating the sensor in a graphical display in response to a detection that a feature weight associated with the measured feature value is less than a weight threshold.

7. The method of any of embodiments 1 to 6, wherein the feature subset comprises a feature indicating a numeric value.

8. The method of any of embodiments 1 to 7, wherein the feature subset comprises a feature indicating a geographic location.

9. The method of any of embodiments 1 to 8, further comprising: retrieving natural language text; using a natural language processing model to assign a set of sentiment scores to a set of text blocks of the natural language text; and selecting the feature subset based on the set of sentiment scores.

10. The method of any of embodiments 1 to 9. further comprising: obtaining a data stream during a session with a client computing device; and determining at least one feature of the set of feature values based on the data stream, wherein determining the set of feature values comprises determining a first feature value of the set of feature values based on a user action via the client computing device.

11. The method of any of embodiments 1 to 10, further comprising: detecting whether the second reward value is within a threshold range; and in response to a detection that the second reward value exceeds the threshold range, modifying the second reward value to be within the threshold range.

12. The method of any of embodiments 1 to 11, further comprising: detecting a set of shapes based on image data; assigning a set of object labels to the set of shapes based on the image data using a transformer neural network; and determining the set of feature values based on the set of object labels.

13. The method of any of embodiments 1 to 12, the operations further comprising: obtaining a document comprising text data; determining a match based on the text data and a set of identifiers indicating one or more character sequences; and determining the set of policy parameters based on the set of identifiers that match with one or more character sequences of the text data.

14. The method of any of embodiments 1 to 13, the operations further comprising selecting a subset of feature weights of the set of feature weights based on a feature subset of the features indicated by the set of policy parameters, wherein the feature subset comprises a feature indicating a categorical value, and wherein determining the reward modification value comprises determining the reward modification value based on the subset of feature weights.

15. The method of any of embodiments 1 to 14, wherein determining the second reward value comprises adding the reward modification value to the first reward value.

16. The method of any of embodiments 1 to 15, wherein determining the reward modification value comprises: determining a first feature order determined by the set of feature weights; determining an edit distance based on the first feature order and a second feature order associated with the set of policy parameters; and determining the reward modification value based on the edit distance.

17. The method of any of embodiments 1 to 16, wherein determining the reward modification value comprises: detecting whether the reward modification value exceeds a threshold; and in response to a detection that the reward modification value exceeds the threshold, update the reward modification value to a preset value.

18. The method of any of embodiments 1 to 17, the operations further comprising: determining an application identifier associated with the prediction model; and retrieving a policy parameter of the set of policy parameters based on the application identifier.

19. The method of any of embodiments 1 to 18, the operations further comprising training the prediction model based on a policy and a training set of feature values, wherein training the prediction model comprises: providing the training set of feature values to a set of neural network layers of the prediction model to determine a set of probability values; selecting a candidate action based on the set of probability values; determining an outcome based on the candidate action; and updating the set of model parameters of the prediction model based on the outcome.

20. The method of embodiment 19, wherein the prediction model is associated with a set of policy update constraints, and wherein updating the set of model parameters of the prediction model comprises constraining an update to the set of model parameters based on the set of policy update constraints.

21. One or more tangible, non-transitory, machine-readable media storing instructions that, when executed by a set of processors, cause the set of processors to effectuate operations comprising those of any of embodiments 1 to 20.

22. A system comprising: a set of processors and memory storing computer program instructions that, when executed by the set of processors, cause the set of processors to effectuate operations comprising those of any of embodiments 1 to 20.

What is claimed is:

1. A system for reducing decision-making weights of malicious features during reinforcement learning by reducing a reward value based on local explainability weights for malicious features, the system comprising one or more processors and a non-transitory, computer-readable storage medium storing instructions that, when executed by the one or more processors, cause the one or more processors to perform operations comprising:
providing, to a reinforcement learning model agent configured with a set of model parameters, a set of feature values representing a training state and a training output state to determine an initial reward value, wherein each respective feature value of the set of feature values corresponds with a feature of a feature set;
obtaining local explainability weights for the feature set based on the set of model parameters by performing a local explainability operation that comprises providing the reinforcement learning model agent with a plurality of combinations of candidate feature values to determine the local explainability weights;
selecting a subset of feature weights of the local explainability weights indicated by a subset of policy-flagged features, wherein the feature set comprises the subset of policy-flagged features, and wherein the subset of policy-flagged features represents malicious features;
determining a reward reduction value based on the subset of feature weights;
determining a modified reward value by subtracting the reward reduction value from the initial reward value; and
updating the set of model parameters based on the modified reward value by retraining the reinforcement learning model agent with the modified reward value.

2. The system of claim 1, wherein:
providing the plurality of combinations of candidate feature values to the reinforcement learning model agent comprises determining a plurality of candidate output values as outputs of the reinforcement learning model agent;
performing the local explainability operation further comprises:
determining a set of contribution weights associated with the set of feature values by, for each respective feature of the set of feature values, determining a respective contribution to the plurality of candidate output values; and
setting the local explainability weights to be equal to the set of contribution weights;
the subset of feature weights comprises a selected contribution weight; and
determining the reward reduction value comprises increasing the reward reduction value based on the selected contribution weight.

3. A method comprising:
providing, to a prediction model configured with a set of model parameters, a set of feature values to determine a first reward value, wherein each respective feature value of the set of feature values corresponds with a feature of a feature set;
obtaining a set of feature weights for features of the set of feature values by performing a local explainability operation that comprises providing the prediction model with a set of test inputs to determine a set of feature weights;
selecting a subset of feature weights of the set of feature weights based on a feature subset of the features indicated by a policy parameter of the prediction model;
determining a reward modification value based on the subset of feature weights;
determining a second reward value based on the first reward value and the reward modification value; and
updating the set of model parameters based on the second reward value.

4. The method of claim 3, wherein determining the second reward value comprises reducing the first reward value based on a first feature weight of the subset of feature weights in response to a detection that the first feature weight satisfies a weight threshold.

5. The method of claim 3, wherein the set of feature values comprises a measured feature value provided by a sensor, further comprising indicating the sensor in a graphical display in response to a detection that a feature weight associated with the measured feature value is less than a weight threshold.

6. The method of claim 3, wherein the feature subset comprises a feature indicating a numeric value.

7. The method of claim 3, wherein the feature subset comprises a feature indicating a geographic location.

8. The method of claim 3, further comprising:
retrieving natural language text;
using a natural language processing model to assign a set of sentiment scores to a set of text blocks of the natural language text; and
selecting the feature subset based on the set of sentiment scores.

9. The method of claim 3, further comprising:
obtaining a data stream during a session with a client computing device; and
determining at least one feature of the set of feature values based on the data stream, wherein determining the set of feature values comprises determining a first feature value of the set of feature values based on a user action via the client computing device.

10. The method of claim 3, further comprising:
detecting whether the second reward value is within a threshold range; and
in response to a detection that the second reward value exceeds the threshold range, modifying the second reward value to be within the threshold range.

11. A set of non-transitory, computer-readable media storing instructions that, when executed by one or more processors, cause the one or more processors to perform operations comprising:
providing, to a prediction model configured with a set of model parameters, a set of feature values to determine a first reward value;
obtaining a set of feature weights for features of the set of feature values by performing a local explainability operation based on a set of test inputs for the prediction model;
determining a reward modification value based on the set of feature weights and a set of policy parameters indicating one or more features;
determining a second reward value based on the first reward value and the reward modification value; and
updating the set of model parameters based on the second reward value.

12. The set of non-transitory, computer-readable media of claim 11, further comprising:
detecting a set of shapes based on image data;
assigning a set of object labels to the set of shapes based on the image data using a transformer neural network; and
determining the set of feature values based on the set of object labels.

13. The set of non-transitory, computer-readable media of claim 11, the operations further comprising:
obtaining a document comprising text data;
determining a match based on the text data and a set of identifiers indicating one or more character sequences; and
determining the set of policy parameters based on the set of identifiers that match with one or more character sequences of the text data.

14. The set of non-transitory, computer-readable media of claim 11, the operations further comprising selecting a subset of feature weights of the set of feature weights based on a feature subset of the features indicated by the set of policy parameters, wherein the feature subset comprises a feature indicating a categorical value, and wherein determining the reward modification value comprises determining the reward modification value based on the subset of feature weights.

15. The set of non-transitory, computer-readable media of claim 11, wherein determining the second reward value comprises adding the reward modification value to the first reward value.

16. The set of non-transitory, computer-readable media of claim 11, wherein determining the reward modification value comprises:
determining a first feature order determined by the set of feature weights;
determining an edit distance based on the first feature order and a second feature order associated with the set of policy parameters; and
determining the reward modification value based on the edit distance.

17. The set of non-transitory, computer-readable media of claim 11, wherein determining the reward modification value comprises:
detecting whether the reward modification value exceeds a threshold; and
in response to a detection that the reward modification value exceeds the threshold, updating the reward modification value to a preset value.

18. The set of non-transitory, computer-readable media of claim 11, the operations further comprising:
determining an application identifier associated with the prediction model; and
retrieving a policy parameter of the set of policy parameters based on the application identifier.

19. The set of non-transitory, computer-readable media of claim 11, the operations further comprising training the prediction model based on a policy and a training set of feature values, wherein training the prediction model comprises:
providing the training set of feature values to a set of neural network layers of the prediction model to determine a set of probability values;
selecting a candidate action based on the set of probability values;
determining an outcome based on the candidate action; and
updating the set of model parameters of the prediction model based on the outcome.

20. The set of non-transitory, computer-readable media of claim 19, wherein the prediction model is associated with a set of policy update constraints, and wherein updating the set of model parameters of the prediction model comprises constraining an update to the set of model parameters based on the set of policy update constraints.
